(19) United States
(12) Patent Application Publication
(10) Pub. No.: US 2007/0101189 A1
(43) Pub. Date: May 3, 2007

(54) Storage apparatus, and control method and program

(75) Inventors: Takahiro Shinbori, Kawasaki (JP); Shigenori Yanagi, Kawasaki (JP); Yoshinori Suzuki, Higashine (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/343,844

(22) Filed: Jan. 31, 2006

(30) Foreign Application Priority Data
Oct. 31, 2005 (JP) 2005-315790

(51) Int. Cl. G06F 11/00

(52) U.S. Cl. 714/8

(57) ABSTRACT

A rewrite verify processing unit rewrites read data on a sector requiring the number of times of retry equal to or more than a predetermined number of times during a process of reading a medium, and then perform a verify read. A rewrite verify managing unit records the sector processed by the rewrite verify processing unit and the number of times of processing on a rewrite verify management table, and assigns, and assigns the sector where the number of times of processing has reached a predetermined number of times to an alternative area for exclusion from a process target for a rewrite verify processing process.

This application is a priority based on prior application No. JP 2005-315790, filed Oct. 31, 2005, in Japan.

### BACKGROUND OF THE INVENTION

1. Field of the Invention

The present invention relates to a storage apparatus, such as a magnetic disk apparatus, and a control method and program and, particularly, to a storage apparatus that saves data stored in a defective sector of a medium in an alternative area.

2. Description of the Related Arts

In recent storage apparatuses, such as magnetic disk apparatuses, with the advance of, for example, densification of a medium and decrease in the floating amount of a head, and with the sector size of the medium being made finer, a subsequent influence of a flaw occurring while the apparatus is being used has become increased. Upon recognizing a defective sector in which data cannot be normally recorded due to a subsequent flaw or like, the storage apparatus records data by allocating an alternative sector in an alternative area. For data access to the defective sector, all accesses are made to the data in the alternative sector assigned to the alternative area. This is referred to an alternative assignment (reassignment) process. On the other hand, upon recognizing, during a read process, a sector that is difficult to read, specifically, a sector requiring the number of times of retry equal to or more than a predetermined number of times, verify read is performed in which data read from this sector is rewritten and it is then verified that the data can be read without a retry or with a less number of times of retry. This process is referred to as a rewrite verify process. The rewrite verify process is effective to reduce an influence of writing on a certain cylinder exerted on its adjacent cylinders (cylinder sectors at both adjacent sides of a write sector) and to reduce retries not due to a medium fault (flaw), such as an offset write at the time of writing, and can protect data without an unnecessary increase of sectors for alternative assignment. As a matter of course, if reading cannot be made even with a rewrite verify process, it is highly possible that the medium has a fault, and therefore an alternative assignment process is performed for assigning an alternative sector to an alternative area.

[Patent Document 1] Japanese Patent Laid-Open Publication No. 10-50005

[Patent Document 2] Japanese Patent Laid-Open Publication No. 61-271672

Here, in the conventional storage apparatus, a phenomenon can occur on rare occasions in which reading can be made immediately after rewrite verify onto the sector but becomes difficult or impossible with a lapse of time. Such an unstable sector occurs because a subtle flaw or a flaw subsequently created on the medium is expanded with a lapse of time, or other reasons. The unstable sector on which a flaw on the medium is expanded with time cannot be detected through a verify process immediately after rewriting, and therefore an alternative assignment process is not performed. Every time a predetermined number of times of retry is required, a data rescue through a rewrite verify process is performed. However, a problem occurs such that the flaw is expanded as a rewrite verify process is repeated a predetermined number of times, making it impossible to read the data. To solve this problem of rendering the data unreadable, one solution may be such that an alternative assignment process is performed without performing a rewrite verify process when a sector requiring the number of times of retry equal to or more than a predetermined number of times is recognized. This will, however, pose a problem of uselessly increasing alternative assignments at a stage where data can still be rescued through a rewrite verify process, thereby leading to a deterioration in capability and a reduction in product life.

### SUMMARY OF THE INVENTION

According to the present invention is to provide an information recording apparatus, and a control method and program for reliably protecting data without unnecessarily increasing alternative assignments onto a sector being rescued through a rewrite verify process.

The present invention provides a storage apparatus. The storage apparatus according to the present invention includes:

a rewrite verify processing unit that rewrites read data on an access position requiring the number of times of retry equal to or more than a predetermined number of times during a process of reading a medium, and then performs a verify read; and

a rewrite verify managing unit that records the access position processed by the rewrite verify processing unit and the number of times of processing, and assigns the access position where the number of times of processing has reached a predetermined number of times to an alternative process for exclusion from a processing target of the rewrite verify processing unit.

The rewrite verify managing unit records the access position processed by the rewrite verify processing unit and the number of times of processing on a management table, and assigns the access position where the number of times of processing on the management table has reached a predetermined number of times to the alternative process for exclusion from the process target of the rewrite verify processing unit.

The rewrite verify processing unit records a sector position processed by the rewrite verify processing unit and the number of times of processing on the management table for management.

When the verify read fails, the rewrite verify processing unit performs a verify read retry, and when the verify read retry fails, retries the process from the rewrite.

The present invention provides a storage apparatus control method. The storage apparatus control method according to the present invention includes:

a rewrite verify processing step of rewriting read data on an access position requiring the number of times of retry equal to or more than a predetermined number of times during a process of reading a medium, and then performs a verify read; and

a rewrite verify managing step of recording the access position processed in the rewrite verify processing step and the number of times of processing, and assigning the access position where the number of times of processing has reached a predetermined number of times to an alternative process for exclusion from a process target in the rewrite verify processing step.

The present invention provides a program to be executed on a computer of a storage apparatus. The program according to the present invention causes the computer of the storage apparatus to execute steps including:

a rewrite verify processing step of rewriting read data on an access position requiring the number of times of retry equal to or more than a predetermined number of times during a process of reading a medium, and then performs a verify read; and

a rewrite verify managing step of recording the access position processed in the rewrite verify processing step and the number of times of processing, and assigning the access position where the number of times of processing has reached a predetermined number of times to an alternative process for exclusion from a process target in the rewrite verify processing step.

According to the present invention, every time a rewrite verify process is performed on a sector requiring the number of times of retry equal to or more than a predetermined number of times during a process of reading a medium for rescuing data, a sector position and the number of times of rewrite verify process are recorded. When the number of times of processing reaches a predetermined number of times, an alternative assignment process is performed for exclusion from a target for the rewrite verify process. Before the data cannot be read due to expansion of a flaw on the medium, a deterioration in recording film, or the like, the data can be saved in an alternative area for protection. Also, an alternative assignment process is performed only on the sector where the number of times of repetition for rescue through a rewrite verify process reaches a predetermined number of times. With this, a deterioration in apparatus capability and a reduction in apparatus life can be prevented. The above and other objects, features, and advantages of the present invention will become more apparent from the following detailed description with reference to the drawings.

### BRIEF DESCRIPTION OF THE DRAWINGS

FIG. 1 is a block diagram of a magnetic disk apparatus showing one embodiment of a storage apparatus according to the present invention;

FIG. 2 is a drawing for describing a rewrite verify management table of FIG. 1;

FIG. 3 is a flowchart of a read process according to the embodiment of FIG. 1; and

FIG. 4 is a flowchart of a further specific read process according to the embodiment of FIG. 1.

### DETAILED DESCRIPTION OF THE PREFERRED EMBODIMENTS

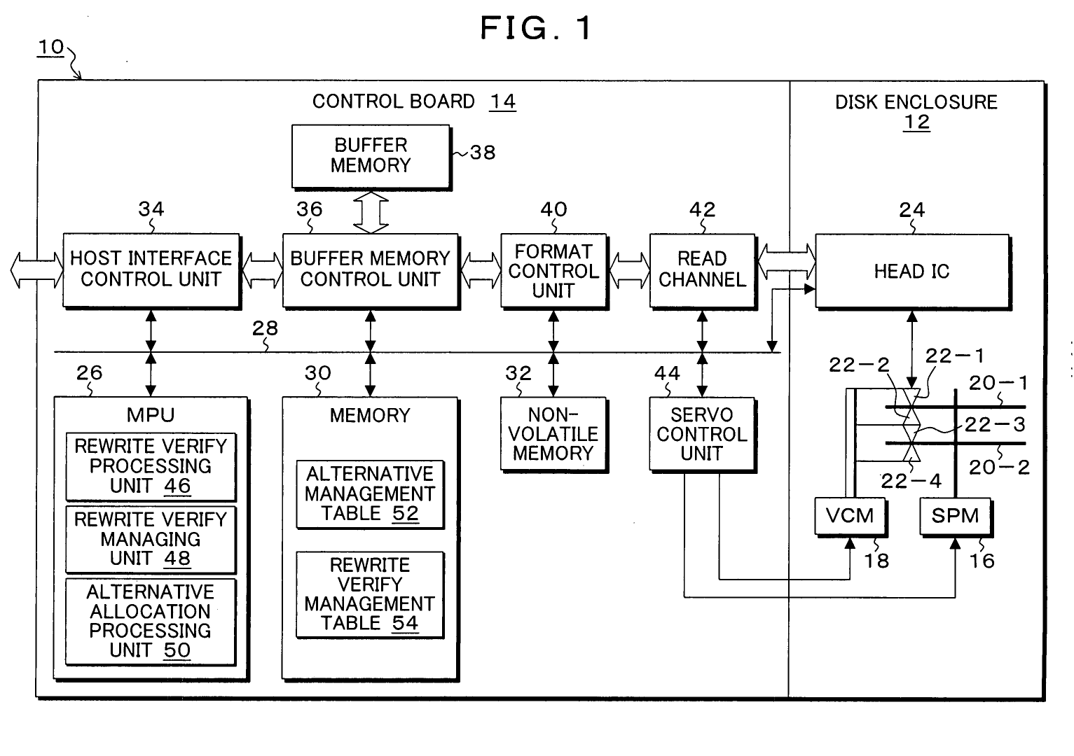

FIG. 1 is a block diagram of a magnetic disk apparatus as one embodiment of a storage apparatus according to the present invention. In FIG. 1, a magnetic disk apparatus 10 known as a hard disk drive (HDD) is constituted of a disk enclosure 12 and a control board 14. The disk enclosure 12 is provided with a spindle motor 16, and disk media (recording media) 20-1 and 20-2 are mounted on the rotational axis of the spindle motor 16 and rotated at a constant speed. The disk enclosure 12 is provided with a voice coil motor 18, and the voice coil motor 18 drives a head actuator having mounted on a tip of its arm heads 22-1 to 22-4 to position the heads 22-1 to 22-4 relative to a recording face of the media. A write head and a read head are integrally mounted on the heads 22-1 to 22-4. The heads 22-1 to 22-4 are connected to a head IC 24 through a signal line, and the head IC 24 selects one head by a head select signal based on a write command or read command from a host as a higher-level apparatus to perform writing or reading. Further, the head IC 24 is provided with a write amplifier for write system and a preamplifier for read system. The control board 14 is provided with a MPU 26, and a bus 28 of the MPU 26 is provided with a memory 30 for storing therein a control program and control data using a RAM and a non-volatile memory 32 for storing therein a control program using a FROM or the like. The bus 28 of the MPU 26 is provided with a host interface control unit 34, a buffer memory 38 for controlling a buffer memory control unit 36, a format control unit 40 functioning as a hard disk controller, a read channel 42 functioning as a write modulating unit and a read demodulating unit, and a servo control unit 44 for controlling the voice coil motor 18 and the spindle motor 16. The magnetic disk apparatus 10 performs writing processing and reading processing based on input/output commands for the host. Here, the normal operation in the magnetic disk apparatus 10 will be explained as follows. When the host interface control unit 34 receives a write command and write data from the host, it decrypts the write command in the MPU 26 and stores the received write data in the buffer memory 38 as needed, and thereafter converts it to a predetermined data format in the format control unit 40, adds an ECC code by the ECC processing, and performs scrambling, RLL code converting and write compensating in the write extending system in the read channel 44 and then writes it on the disk medium 20-1, for example, from the write head of the head 22-1 selected through the head IC 24 from the write driver. At this time, a head positioning signal is given to the servo control unit 44 using DSP or the like from the MPU 26, and the voice coil motor 18 seeks the head to a target track instructed by the command to perform on-track and track following control. On the other hand, when the host interface control unit 34 receives a read command from the host, it decrypts the read command in the MPU 26 and amplifies a read signal read out from the read head selected by the head select of the head IC 24 and amplified by the read amplifier, and then inputs it in the read demodulating system of the read channel 42 and demodulates the read data by virtual response maximum likelihood detection (PRML) or the like to detect and correct an error by performing the ECC processing in the format control unit 40, and thereafter buffers it to the buffer memory 38 and transfers the read data from the host interface control unit 34 to the host. In such a read process, when a reading fails, a retry read is performed. If the retry succeeds before the number of times reaches a predetermined maximum number of times of retry, the read data is transferred to the host, thereby causing the procedure to end normally. On the other hand, if read fails even with the maximum number of times of retry operation, the target sector is regarded as a defective sector and, in principle, an alternative assignment process will be performed. In addition to such normal write processing and read processing, in the present invention, for read processing, the MPU 26 is further provided with a rewrite verify processing unit 46 and a rewrite verify managing unit 48. Correspondingly, the memory 30 is provided with a rewrite verify management table 54. Also, in the rewrite verify processing unit 46 and the rewrite verify managing unit 48 according to the present invention, in cooperative association with an alternative assignment process, an alternative assignment processing unit 50 and its associated alternative management table 52 are also shown. When detecting a sector requiring the number of times of retry equal to or more than a predetermined number of times during a read process, the rewrite verify processing unit 46 performs a rewrite verify process of writing, on this sector, data read in a retry read and then performing a verify read. The rewrite verify managing unit 48 stores the sector for which the rewrite verify was performed by the rewrite verify processing unit 46 and the number of times of processing in the rewrite verify management table 54. When the number of times of processing reaches a predetermined number of times for the same sector, for example, when the number of times of processing reaches three, the sector is assigned to an alternative process area so as to be taken as a process target by the alternative assignment processing unit 50 and, at the same time, is deleted from the rewrite verify management table 54 for exclusion from a process target by the rewrite verify processing unit 46.

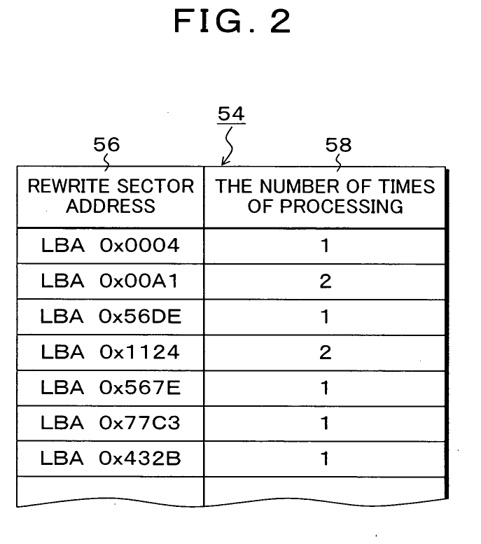

FIG. 2 is a drawing for describing the rewrite verify management table 54 provided to the memory 30 of FIG. 1. The rewrite verify management table 54 is configured so as to have registered thereon a rewrite sector address 56 and the number of times of processing 58. As the rewrite sector address 56, for example, a logical block address is used. On the rewrite verify management table 54, a sector address of a target sector when a first rewrite verify process is performed at the rewrite verify processing unit 46 is registered. Also, as the number of times of processing 58, an initial value of “1” is registered. Then, when a rewrite verify process is performed on the same sector address, the number of times of processing 58 is counted up by 1. Furthermore, for example, when the number of times of processing reaches three, the rewrite sector address is taken as a target sector for an alternative assignment process. Therefore, in this case, information about the rewrite sector address targeted for an alternative assignment process and its number of times of processing are deleted from the rewrite verify management table 54.

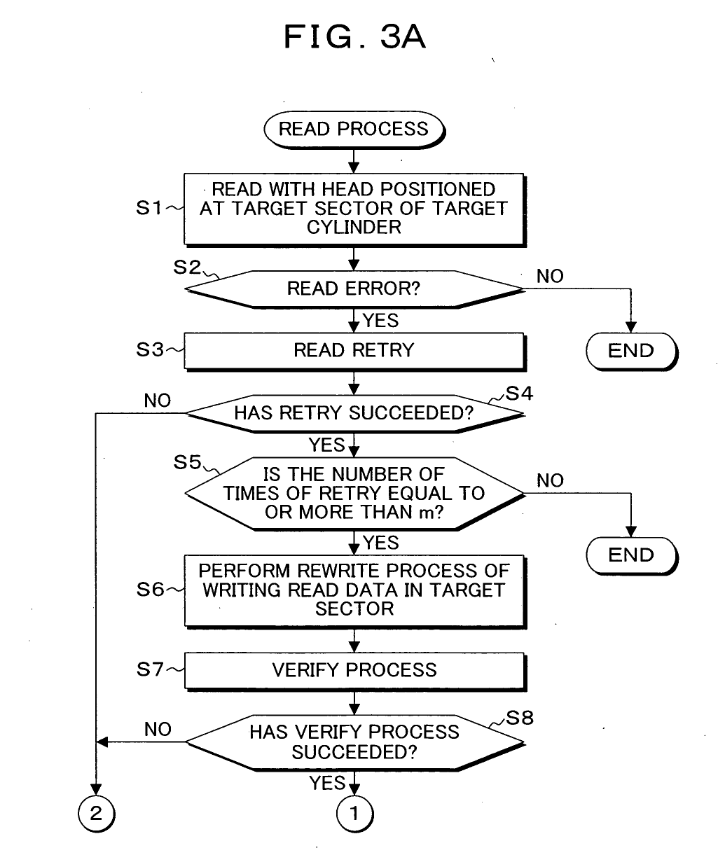

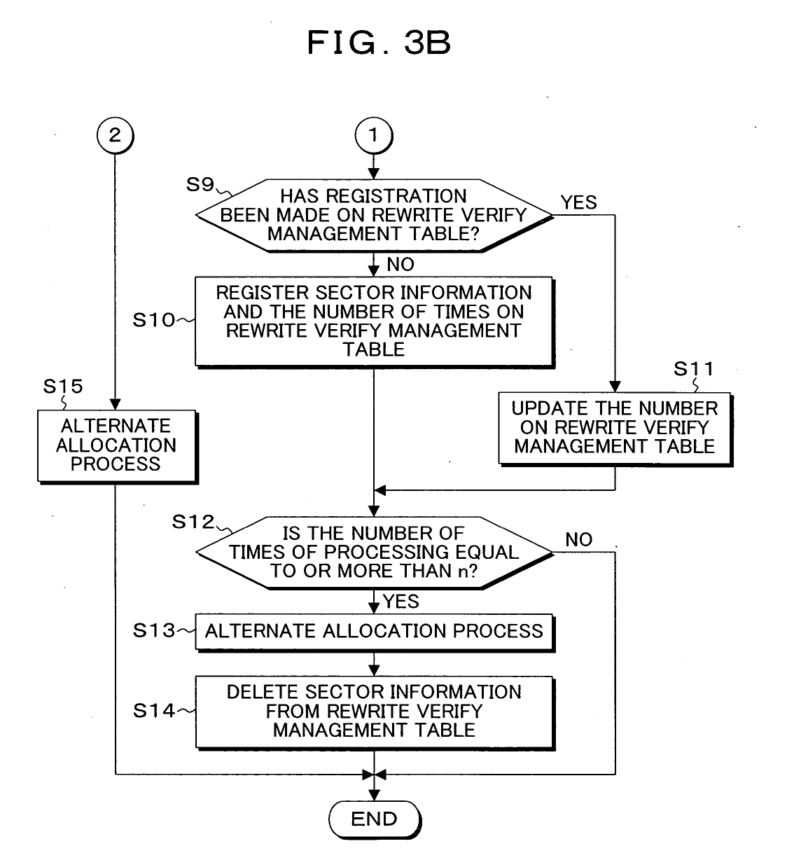

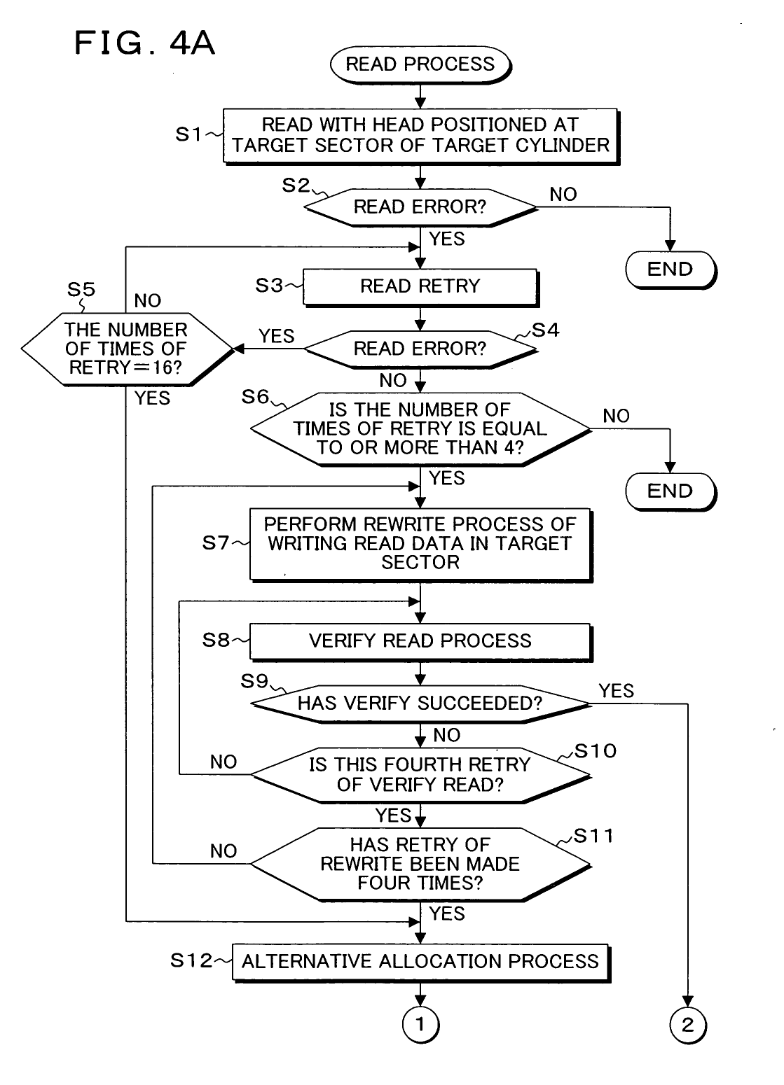

FIG. 3 is a flowchart of a read process according to the embodiment of FIG. 1. In FIG. 3, the read process is performed in which reading is performed in step S1 with the head positioned at the target sector of the target cylinder based on a read command. If this read is determined as succeeding in step S2, the read process ends. When a read error occurs, a read retry is performed in step S3. In step S4, it is checked whether the read retry has succeeded. In case of a retry failure, an alternative assignment process for the target sector is performed in step S14. If it is checked in step S4 that the read retry has succeeded, the procedure goes to step S5, wherein it is checked whether the number of times of retry is equal to or more than a predetermined number of times m. If the number of times is less than m, the read process normally ends. If the number of times of retry is equal to or more than m, a rewrite process of rewriting the data read through retry in the target sector is performed in step S6. Then in step S7, a verify process of reading the rewritten data for verification is preformed. It is then checked in step S8 whether the verify process has succeeded. If the verify process has failed, the rewrite verify process has not been able to be done. Therefore, in step S5, an alternative assignment process is performed. If the verify process has succeeded to normally complete the rewrite verify process, the procedure goes to step S9, wherein it is checked whether registration has been made on the rewrite verify management table 54. For the first time, registration has not been made, and therefore the procedure goes to step S10, wherein sector information and the number of times of processing are registered on the rewrite verify management table 54. In this case, the number of times indicates an initial value of “1”. On the other hand, if it is checked in step S9 that registration has been made on the rewrite verify management table 54, the procedure goes to step S11, wherein updating is performed in which the number of times for the relevant sector address is incremented by 1. Then in step S12, it is checked whether the number of times of processing on the rewrite verify management table 54 is equal to or more than a predetermined number of times n. If the number of times is less than n, the procedure ends. If the number of times of processing has reached n, the procedure goes to step S13, wherein an alternative assignment process is performed. In step S14, the target sector is deleted from the rewrite verify management table 54 for exclusion from a target for the rewrite verify process. With such a rewrite verify process for the sector requiring the predetermined number of times of retry in a read process and such an alternative assignment process when the number of times of rewrite verify processing is equal to or more than the predetermined times, the alternative assignment process is performed before the flaw on the medium is expanded with a lapse of time to make reading impossible as rewrite verify is repeated some times, thereby reliably preventing reading from being unable to be performed due to expansion of the flaw. Also, an alternative assignment process is not performed until the number of times reaches a predetermined number of times that allows a data rescue measure in a rewrite verify process to be effective, thereby preventing a deterioration in apparatus capability and a reduction in life of the apparatus itself due to an unnecessary increase in alternative assignment.

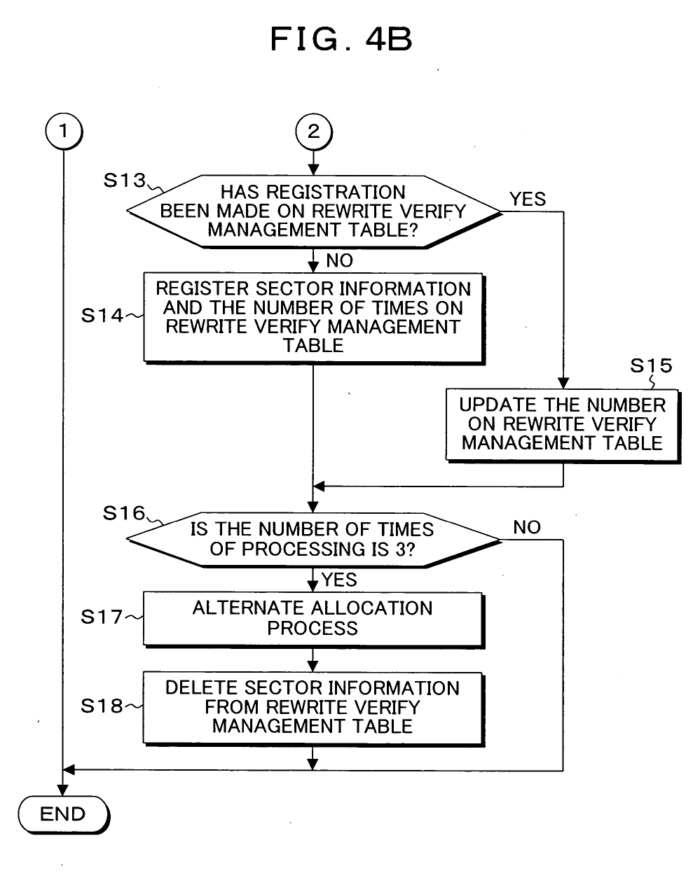

FIG. 4 is a flowchart of a further specific read process in the embodiment of FIG. 1. In this flowchart, the case is exemplarily in which the maximum number of times of retry in response to a read error is 16, the number of times m of retry for a rewrite verify process upon success of the read retry is m=4 and, further, the number of times n for performing alternative assignment by repeating the rewrite verify process is n=3. In FIG. 4, based on a read command from the host, in step S1, the head is positioned at the target sector of the target cylinder for reading. In case of an read error in step S2, a read retry is performed in step S3. If a read error is found in this read retry in step S4, a read retry is repeated from step S3 until the number of times of retry reaches 16 in step S5. If the number of times of read retry reaches 16 in step S5, it is determined that the sector is a defective sector, and then the procedure goes to step S12 wherein an alternative assignment process is performed. If normal read is found in step S4 before the number of times of retry reaches 16, the procedure goes to step S6, wherein it is checked whether the number of times of retry with read success is equal to or more than 4. If the number of times is less than 4, the process normally ends. If the number of times is equal to or more than 4, it is determined that the sector is difficult to read, and then in step S7, a rewrite process is performed in which the data read through read retry is written in the target sector. Then in step S8, a verify process of reading the data from the target sector for verification is performed, and then in step S9, it is checked whether verify has succeeded. If verify has failed, it is checked in step S10 whether the number of times of retry for verify read is 4. If the number of times is less than 4, the procedure returns to step S8, wherein a verify read process is repeated. If the number of times of failure in verify read reaches 4 in step S10, it is checked in step S11 whether the number of times of retry for rewrite is 4. If the number of times is less than 4, the procedure returns to step S7, wherein a further rewrite verify process is performed. Thereafter, the processes in steps S7 to S10, that is, those in which a rewrite verify process is performed once and then verify read is performed four times, are repeated. Nevertheless, if verify has not succeeded, the sector is regarded as a defective sector, and then an alternative assignment process is performed in step S12. If it is determined in step S9 that verify has succeeded in the course of repetition of the rewrite verify process and retry of verify read in steps S7 to S11, the procedure goes to step S13, wherein it is checked whether the target sector has been registered on the rewrite verify management table 54. If not registered, a sector address and an initial number of times are registered on the rewrite verify management table 54 in step S14. If already registered, the procedure goes to step S15, wherein the number of times of the target sector on the rewrite verify management table 54 is incremented by 1 in step S15. Then in step S16, it is checked whether the number of times of processing on the target sector on the rewrite verify management table 54 is 3. If the number of times is less than 3, the process ends. If the number of times reaches 3, the procedure goes to step S17, wherein it is determined that it is highly possible that reading will become impossible due to expansion of a flaw, and an alternative assignment process is performed. In step S18, sector information of the target is deleted from the rewrite verify management table 54 for exclusion from a target in the rewrite verify process. Also, the present invention provides a control program to be executed by a computer of the magnetic disk apparatus of FIG. 1, that is, the MPU 26. This program has contents of the read process according to the flowchart of FIG. 3, specifically, the flowchart of FIG. 4. Here, in the above embodiment, the number of times of processing corresponding to the rewrite sector address is counted up on the rewrite verify management table 54 of FIG. 2 for each rewrite verify process and, if the number of times reaches the predetermined number of times, 3 for example, an alternative process is performed. An alternative assignment process may be performed in consideration of, in addition to this number of times of processing, an elapsed time from the rewrite verify process. For example, if the number of times of processing for transition to an alternative assignment process is 3, an elapsed time T1 from rewrite is set when the number of times of processing is 1. When the number of times of rewrite is 2, a further shorter elapsed time T2 is set for the second time. In this state, if a lapse of the T1 time is found for the first-time process even if a third-time rewrite is not performed, an alternative assignment process may be performed at the point of a lapse of the T2 time for the second-time process for exclusion from a target of the rewrite verify process. When an elapsed time after such rewrite reaches a predetermined time, reading is regarded as being impossible due to expansion of a flaw and an alternative assignment process is performed. With this, after registration on the rewrite verify management table 54, alternative assignment is forcefully performed for rescue on a sector that have not been read for a long time. Still further, the present invention includes appropriate modifications without impairing its objects and advantages, and is also not restricted by numerical values shown in the above embodiment. Still further, although the above embodiment takes a magnetic disk apparatus as an example of the storage apparatus, the present invention can be directly applied to another storage apparatus as long as it is a storage apparatus having a structure using a medium and a head.

What is claimed is:

1. A storage apparatus comprising:
a rewrite verify processing unit that rewrites read data on an access position requiring the number of times of retry equal to or more than a predetermined number of times during a process of reading a medium, and then performs a verify read; and
a rewrite verify managing unit that records the access position processed by the rewrite verify processing unit and the number of times of processing, and assigns the access position where the number of times of processing has reached a predetermined number of times to an alternative process for exclusion from a processing target of a rewrite verify processing unit.

2. The storage apparatus according to claim 1, wherein the rewrite verify managing unit records the access position processed by the rewrite verify processing unit and the number of times of processing on a management table, and assigns the access position where the number of times of processing on the management table has reached the predetermined number of times to the alternative process for exclusion from the process target of the rewrite verify processing unit.

3. The storage apparatus according to claim 1, wherein the rewrite verify processing unit records a sector position processed by the rewrite verify processing unit and the number of times of processing on the management table for management.

4. The storage apparatus according to claim 1, wherein, when the verify read fails, the rewrite verify processing unit performs a verify read retry, and when the verify read retry fails, retries the process from the rewrite.

5. A storage apparatus control method comprising:
a rewrite verify processing step of rewriting read data on an access position requiring the number of times of retry equal to or more than a predetermined number of times during a process of reading a medium, and then performs a verify read; and
a rewrite verify managing step of recording the access position processed in the rewrite verify processing step and the number of times of processing, and assigning the access position where the number of times of processing has reached a predetermined number of times to an alternative process for exclusion from a process target in the rewrite verify processing step.

6. The storage apparatus control method according to claim 5, wherein, in the rewrite verify managing step, the access position processed in the rewrite verify processing step and the number of times of processing are recorded on a management table, and the access position where the number of times of processing on the management table has reached a predetermined number of times is assigned to the alternative process for exclusion from the process target in the rewrite verify processing step.

7. The storage apparatus control method according to claim 5, wherein, in the rewrite verify processing step, a sector position processed in the rewrite verify processing step and the number of times of processing are recorded on the management table for management.

8. The storage apparatus control method according to claim 5, wherein, in the rewrite verify processing step, when the verify read fails, a verify read retry is performed, and when the verify read retry fails, the process from the rewrite is retried.

9. A computer-readable storage medium which stores a causing a computer of a storage apparatus to execute steps comprising:
a rewrite verify processing step of rewriting read data on an access position requiring the number of times of retry equal to or more than a predetermined number of times during a process of reading a medium, and then performs a verify read; and
a rewrite verify managing step of recording the access position processed in the rewrite verify processing step and the number of times of processing, and assigning the access position where the number of times of processing has reached a predetermined number of times to an alternative process for exclusion from a process target in the rewrite verify processing step.

10. The storage medium according to claim 9, wherein, in the rewrite verify managing step, the access position processed in the rewrite verify processing step and the number of times of processing are recorded on a management table, and the access position where the number of times of processing on the management table has reached a predetermined number of times is assigned to the alternative process for exclusion from the process target in the rewrite verify processing step.

11. The storage medium according to claim 9, wherein, in the rewrite verify processing step, a sector position processed in the rewrite verify processing step and the number of times of processing are recorded on the management table for management.

12. The program according to claim 9, wherein, in the rewrite verify processing step, when the verify read fails, a verify read retry is performed, and when the verify read retry fails, the process from the rewrite is retried.
